(19) United States
(12) Patent Application Publication
(10) Pub. No.: US 2024/0396412 A1
(43) Pub. Date: Nov. 28, 2024

(54) STABILISED END ZONE REGIONS OF A LAMINATED STATOR CORE BY SEGMENTS, ELECTRICAL MACHINE AND METHOD OF PRODUCTION OR REPAIR

(71) Applicant: Siemens Energy Global GmbH & Co. KG, Munich, Bayern (DE)

(72) Inventors: Kais Belhareth, Mulheim an der Ruhr (DE); Ralf Merte, Dortmund (DE)

(73) Assignee: Siemens Energy Global GmbH & Co. KG, Munich, Bayern (DE)

(21) Appl. No.: 18/694,976

(22) PCT Filed: Sep. 8, 2022
(86) PCT No.: PCT/EP2022/074929

§ 371 Date: Mar. 24, 2024

(30) Foreign Application Priority Data
Oct. 7, 2021 (DE) 10 2021 211 307.9

(51) Int. Cl. H02K 15/00; H02K 1/18; H02K 1/20

(52) U.S. Cl. CPC H02K 15/0006; H02K 1/18; H02K 1/20

(57) ABSTRACT

A segment for stabilizing an end zone region of a laminated core. The end zone region has a stepped portion on the end, wherein the segment has a lower part and an upper part, wherein the lower part is designed with a matching stepped portion complementary to the stepped portion, wherein the upper part is arranged on the lower part and is held in the radial direction by mechanical engagement from behind.

### CROSS REFERENCE TO RELATED APPLICATIONS

This application is the US National Stage of International Application No. PCT/EP2022/074929 filed 8 Sep. 2022, and claims the benefit thereof, which is incorporated by reference herein in its entirety. The International Application claims the benefit of German Application No. DE 10 2021 211 307.9 filed 7 Oct. 2021.

### FIELD OF INVENTION

The invention relates to stabilized end zone regions of a laminated stator core of an electric machine by segments and a method of production or repair.

### BACKGROUND OF INVENTION

During the deployment of an electric machine, there is a loosening of baked and/or pressed layers of the laminated core and/or material breakouts in tooth tips of a laminated core stepped portion, the end zone region of the laminated stator core, and the loss of mechanical and electromagnetic integrity as a result.

The integrity, both mechanical and electromagnetic, is compromised by this damage pattern, to the extent that it can lead to complete loss of the electric machine within a very short time.

This is caused by the detachment of individual sheets from the end zone and further exacerbated by a rapid progression of secondary damage. This includes mechanical degradation of the adjacent end zone regions, damage to the stator coil held in the stator core and the insulation thereof, thermal overload due to the uncontrolled effect of eddy currents on damaged regions with sharp edges. Consequently, secondary damage can occur due to separated and wandering pieces of sheet metal and parts of the end zone, and also a stator short circuit due to damage to the stator insulation.

For repairs, in electric machines such as generators, for example, the entire laminated stator core has been replaced by a new one.

The production of a new laminated core in the case of turbo-generators or phase shifters typically takes 12 to 18 months, depending on the complexity of the respective machine design.

### SUMMARY OF INVENTION

Therefore, an object of the invention is to solve the aforementioned problem.

The object is achieved by a segment for a stabilized end zone region, a method, and an electric machine according to the claims.

Further advantageous measures that can be combined arbitrarily with one another to achieve further advantages are listed in the dependent claims.

### BRIEF DESCRIPTION OF THE DRAWINGS

In the drawing

FIG. 1 shows the initial situation in the invention

FIG. 2 shows a lower part of a segment

FIG. 3 shows an upper part of a segment

FIGS. 4, 5, 6, 7 show different views of a segment

FIG. 8 shows segments that form a ring.

### DETAILED DESCRIPTION OF INVENTION

The figures and the description represent only exemplary embodiments of the invention.

Stabilization is achieved particularly by fixing the metal sheets to one another by bonding with a 2-component resin mixture. Any voids that may have formed due to separated sheet metal parts or other elements in the end zone areas are filled with plugs (filler pieces) made of glass fiber reinforced plastic (GFK), along with fleece mats and a 2-component resin mixture, firmly connecting them to the end zone area.

Regions of individual metal sheets showing separations are filled by lining with plates adapted to the damaged regions, in particular GRP plates.

In order to achieve sufficient axial tension (design-dependent) in the loose composite of the end zone regions, in addition self-locking wedges, in particular, that are specially made for this purpose can be driven into radial cooling slots.

The restoration of the integrity of the end zone structure or a renewed loss of sheet metal parts or other elements of the end zone through renewed detachment or separation is avoided by using a ring-shaped support structure formed by segments.

The individual segments are connected to one another both by positive locking (similar to the tongue-and-groove principle) and also by positive locking to the wedge groove of the stator slots.

The segments each have, or each consist of, an upper part axially inserted into the stator slot and a lower part placed radially on the stepped portion of the end zone region. The segments (upper and lower parts and also adjacent segments) are connected to one another, in particular additionally by a 2-component resin mixture.

In order to prevent axial slipping, the segments are preferably fixed with a non-magnetic metal angle welded to the cover of the pressure fingers by a pin or screw connection. This prevents both axial movements towards the end shield (housing end) of the machine and radial lifting of the segments from the stepped region of the laminated core.

### Variants:

Variant 1: Active cooling of the end zone region can be enabled via an overflow channel.

Variant 2: Active cooling of the end zone region can be enabled by maintaining the existing radial cooling paths through radial holes in the segments.

The presented invention, depending on the operating mode of the electric machine, such as active/reactive power operation, basic/medium or peak load operation, etc. can serve as a corrective measure for the short-term bridging period for the production of a new center section/stator for replacement or as a medium-term, or possibly also as a long-term, stabilization of the existing damage profile.

1. Application in the field of turbo-generators/phase shifters: Since there is no partial repair possibility for a damage manifestation of this kind (partial separation/separation of metal sheets and/or complete partial packages of half-teeth/teeth and/or components of the laminated core and/or surface erosion) or this damage mechanism (voltage loss in the end zone region of the laminated stator core), in case of known damages to turbo-generators, for example, the entire laminated stator core in the generator housing or the entire center stator section has been replaced.

In the case of fully impregnated (FVPI) designs, the entire stator winding must also be renewed. In this case, the affected turbo set is shut down for 12 to 18 months, depending on the complexity of the respective design and the availability of the materials required.

The presented invention enables partial in-situ repairs where, for example, only the generator rotor needs to be pulled out in the case of generators. In this case, the generator housing remains on the foundation, and the repair takes place at the open ends of the housing. A similar procedure is possible with phase shifters.

Where there is sufficient knowledge of the specific design, even repairs to competitors' generators can be completed within a period of six to twelve weeks.

2. Application in the field of electric machines:

The invention described above can also be applied in the same way in the field of electric machines (motors, etc.) to enable short-term recommissioning.

In addition to lengthy production times, savings in terms of resources and materials can generally provide a substantial advantage.

The main advantage of the invention lies in the fact that a machine taken out of operation due to damage can be put back into operation again in the short term, in order to bridge the period for the production of a replacement for sustainable operation.

This facilitates maximum availability for the respective customer and their insurer.

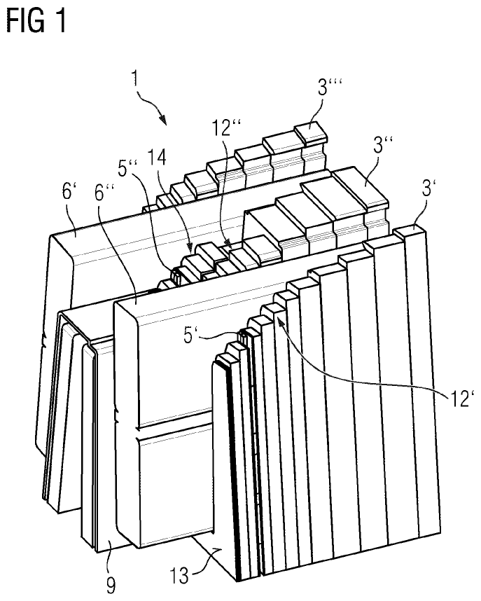

The initial situation for the object of the invention is depicted in FIG. 1.

A laminated core 1 with various end zone regions 3′, 3″, 3″ of a stator is shown.

Between the end zone regions 3′, 3″, 3″, insulation material 6′, 6″ is present for support, said material being compressed by a pressure plate 9.

The individual end zone regions 3′, 3″, 3″ each have a gradual stepped portion (sharp stepped portion) 12′, 12″, etc. at the end towards their end face 13 which, as described above, indicates a loss of material 14 for the middle end zone region 3′.

Cooling air supply ducts 5′, 5″, etc. are also present between the individual laminated cores, particularly close to the end face 13.

The cooling air supply ducts 5′, 5″, etc. preferably run in a radial direction.

A fan that is not shown in detail pushes air through the cooling air supply ducts 5′, 5″, etc., causing cooling.

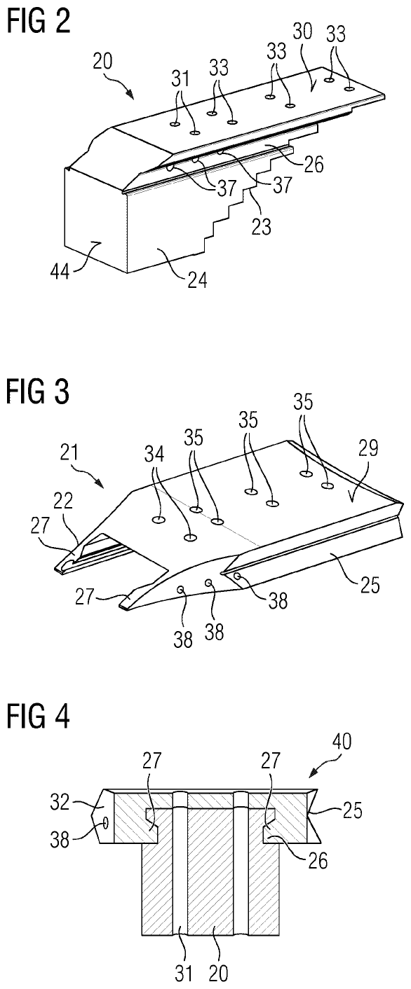

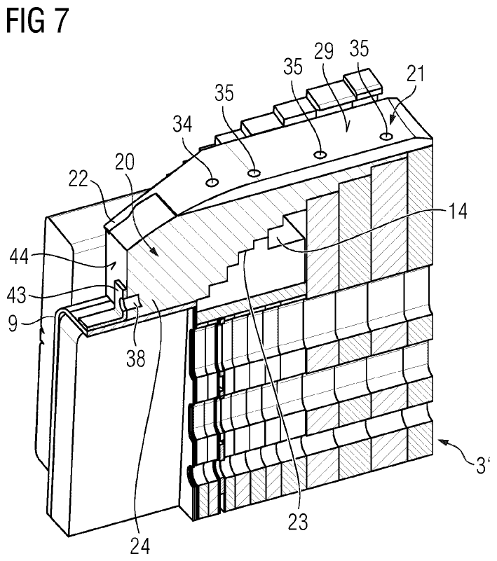

The end zone regions 3′, 3″, etc. are stabilized by two-part segments 40 (FIG. 4) as follows (FIGS. 2-7).

A lower part 20 of the segment 40 is shown in FIG. 2, which is designed on its underside with a corresponding matching stepped portion 23 that complements the stepped portions 12′, 12″, etc., on the end zone region 3′, 3″, etc. The matching stepped portion 23 of the lower part 20 can be individually adapted or may have a standard geometry corresponding to the original geometry.

In the latter case, the material loss 14 is preferably compensated for as described above.

The width of the lower part 20 preferably corresponds to the width of the end zone region 3′, 3″, 3′″, etc.

A front part 24 of the lower part 20 rests on the stepped portion 12, particularly on the pressure plate 9, and preferably extends beyond the end face 13 of the end zone region 3′, 3″, 3′″, etc. (FIG. 7).

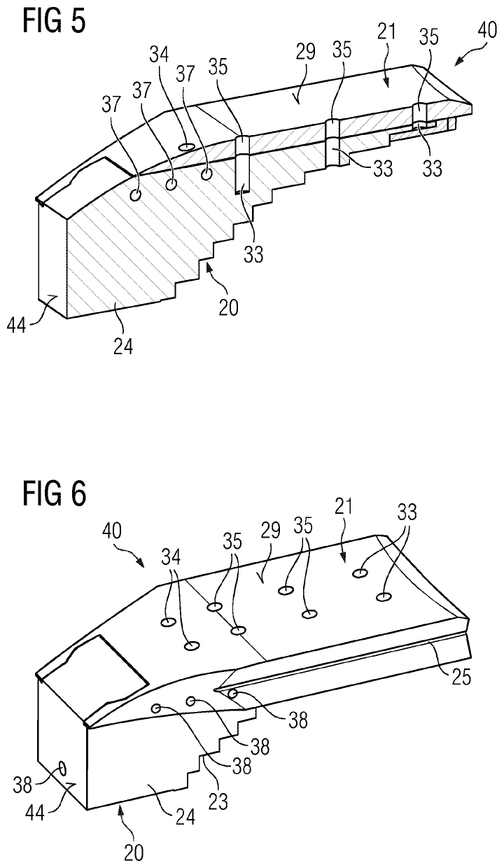

Moreover, the lower part 20 preferably has through-holes 31 on its flat top surface 30, which align with through-holes 34 in an upper part 21 (FIG. 3).

Air flows from the cooling air supply ducts 5′, 5″, etc., through the through-holes 31.

The through-holes 31 are preferably arranged close to the front part 24 of the lower part 20.

There are preferably two through-holes 31 arranged side by side, in other words in the radial circumferential direction. The number and arrangement of the through-holes 31 may vary.

Axial fastening holes 37 are preferably present on the longitudinal side of the lower part 20.

The number and arrangement of the axial fastening holes 37 may vary.

Furthermore, additional radial fastening holes 33 are present on the top surface 30 of the lower part 20, which fastening holes align with radial fastening holes 35 in the upper part 21.

The number and arrangement may vary.

On each of the longitudinal sides of the lower part 20, there is preferably an indentation 26 for fastening the upper part 21 (FIG. 3) to the lower part 20.

The material loss 14 can also be compensated for by the lower part 20.

The upper part 21 of the segment 40 is shown in FIG. 3. The upper part 21 has a flat design.

In addition, the upper part 21 has two side walls 22 that extend from a flat top surface 29.

The upper part 21 has a correspondingly wider design than the lower part 20, so that it can enclose the lower part 20 with its side walls 22.

The upper part 21 is preferably slid onto the lower part 20 from the front or from the back and held in place on the lower part 20 in the radial direction by a mechanical rear interlocking mechanism, as can also be seen in the sectional view according to FIG. 4.

An indentation 27 on the inside of the side wall 22 of the upper part 21 engages with the indentations 26 on the lower part 20 in this case.

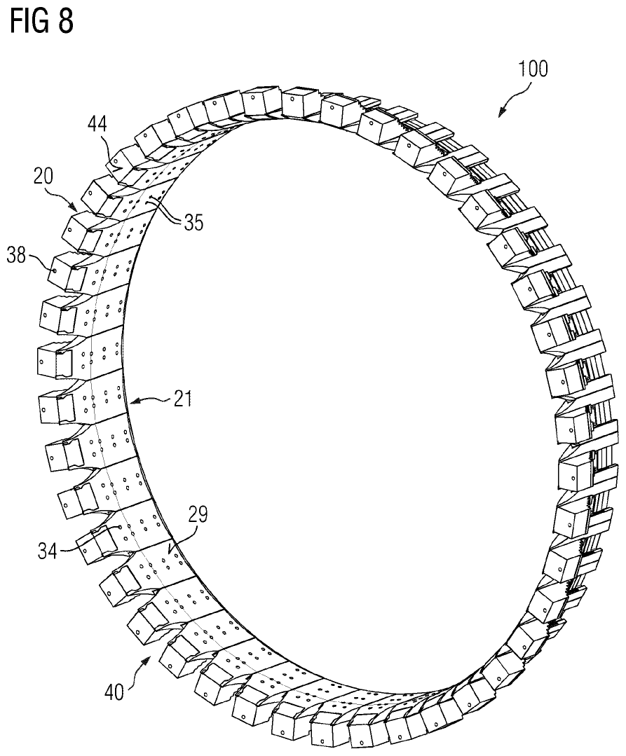

The upper part 21 has a tongue-and-groove geometry 25, 32 on the side surfaces, so that adjacent upper parts 21 in each case interlock with one another in the circumferential direction (FIG. 8).

Through-holes 34 on the top surface 29 of the upper part 21 align with the through-holes 31 of the lower part 20, allowing cooling air from the cooling air supply ducts 5 to flow through the segment 40.

Axial fastening holes 38 are present on the longitudinal side of the upper part 21. The number and arrangement of the axial fastening holes 38 may vary but they are aligned with the axial fastening holes 37 of the lower part 20, so that fastening pins can be inserted through both holes 37, 38.

Furthermore, additional radial fastening holes 35 are present as through-holes on the top surface 29 of the upper part 21. The number and arrangement of the radial fastening holes 35 may vary, but they are aligned with the radial fastening holes 33 of the lower part 20, so that radial fastening pins can be inserted into both holes 33, 35.

FIG. 5 shows the segment 40 assembled from the lower part 20 and the upper part 21 in another sectional representation with different through-holes serving cooling 31, 34 or fastening 33, 35, 37, 38 purposes.

FIG. 6 shows the segment 40 composed of the lower part 20 and upper part 21 in plan view.

A blind hole 38 is preferably formed at the front part 24 on the end face 44.

FIG. 7 shows the segment 40 applied to the initial situation according to FIG. 1.

The defect 14 caused by the loss of material can be observed. However, this defect 14 has already been filled in advance, as described above.

Also noticeable is an angle 43 on the pressure plate 9, against which the end face 44 of the lower part 20 rests.

The angle 43 has a through-hole through which a fastening pin can be inserted into the blind hole 38 of the front part 24 on the end face 44 of the lower part 20.

FIG. 8 shows a ring construction with the support structure described above composed of the segments 40.

Even on undamaged end zone regions 3′, 3″, 3′″, the segments 40 are likewise applied to achieve a stable ring construction 100.

FIG. 8 may represent an arrangement for a newly produced electric machine, but it can also represent a repaired machine.

With a repaired machine, the segments 40 do not need to be distributed around the entire circumference.

Similarly, the ring construction 100 can be applied to a new electric machine.

1. A segment for stabilizing an end zone region of a laminated core, wherein the end zone region has a stepped portion at an end, comprising:
a lower part and an upper part of the segment,
wherein the lower part is designed with a matching stepped portion that complements the stepped portion of the end zone region, and
wherein the upper part is arranged on the lower part.

2. The segment as claimed in claim 1,
wherein the segment has continuous cooling ducts in the lower part and the upper part.

3. The segment as claimed in claim 1,
wherein the upper part is geometrically interlocked together with other adjacent upper parts.

4. The segment as claimed in claim 1, further comprising:
through-holes in the upper part and holes in the lower part through which the fastening pins are inserted.

5. The segment as claimed in claim 1,
wherein an angle is fastened in the end zone region, against which the segment rests.

6. The segment as claimed in claim 1,
wherein the segment comprises plastic.

7. A method of production or repair of an end zone region of an electric machine, comprising:
applying the segments according to claim 1 around an entire circumference of a stator in the end zone region,
wherein defects in the end zone region have been filled for a repair.

8. A newly produced or repaired electric machine with a stabilized end zone region of a laminated core, comprising:
the segments as claimed in claim 1 which are applied around a circumference.

9. The segment as claimed in claim 1,
wherein the upper part is directly arranged on the lower part.

10. The segment as claimed in claim 1,
wherein the upper part is slid onto an upper surface of the lower part and is held in place in a radial direction by a mechanical rear interlocking mechanism.

11. The segment as claimed in claim 3,
wherein the upper part is interlocked by tongue-and-groove geometry together with other adjacent upper parts.

12. The segment as claimed in claim 4,
wherein the holes in the lower part comprise blind holes through which the fastening pins are inserted.

13. The segment as claimed in claim 5,
wherein the segment is locked by a fastening pin through a through-hole in the angle and a hole in the lower part.

14. The segment as claimed in claim 6,
wherein the lower part and the upper part of the segment comprise plastic, and/or fiber-reinforced plastic, and/or are made from plastic.

15. The electric machine as claimed in claim 8,
wherein the segments are applied around an entire circumference.

16. The electric machine as claimed in claim 15,
wherein the segments are applied around the entire circumference forming a ring construction.
